(19) United States
(12) Patent Application Publication
(10) Pub. No.: US 2025/0091917 A1
(43) Pub. Date: Mar. 20, 2025

(54) METHOD FOR WATER PURIFICATION THROUGH FRESH GENERATION OF FLOCCULANT, AND APPARATUS APPLICABLE THERETO

(71) Applicants: Tao Ye, Guangzhou (CN); Yiting Ye, Guangzhou (CN)

(72) Inventors: Tao Ye, Guangzhou (CN); Yiting Ye, Guangzhou (CN)

(21) Appl. No.: 18/961,586

(22) Filed: Nov. 27, 2024

Related U.S. Application Data
(63) Continuation of application No. PCT/CN2023/096599, filed on May 26, 2023.

(30) Foreign Application Priority Data
May 27, 2022 (CN) 202210584264.0
Jun. 14, 2022 (CN) 202210667004.X

(51) Int. Cl. C02F 1/52; C01G 49/02

(52) U.S. Cl. CPC C02F 1/5236; C01G 49/02; C02F 1/5209

(57) ABSTRACT

The present disclosure discloses a method for water purification through fresh generation of a flocculant, including the following steps: (1) mixing a water-purifying agent precursor with a liquid, exciting a resulting mixture, and adding an excited mixture to water to be purified; and/or mixing the water-purifying agent precursor directly with the water to be purified, and exciting a resulting mixture, so that the water-purifying agent precursor undergoes a reaction to produce ferric hydroxide and the ferric hydroxide co-settles with suspended matters and/or impurities in the water to be purified, where the exciting includes addition of an oxidizing substance; and (2) subjecting a mixture obtained in step (1) to SLS to obtain purified water. This method can effectively settle suspended matters in water and adsorb some organic impurities without producing acids and salts during fresh generation of hydroxides, ensuring water-drinking health and reducing the adverse effects of recycling of industrial water.

### CROSS REFERENCE TO RELATED APPLICATIONS

The present application is a Continuation Application of PCT Application No. PCT/CN2023/096599 filed on May 26, 2023, which claims the benefit of Chinese Patent Application Nos. 202210584264.0 filed on May 27, 2022 and 202210667004. X filed on Jun. 14, 2022. All the above are hereby incorporated by reference in their entirety.

### TECHNICAL FIELD

The present disclosure belongs to the technical field of water purification, and specifically relates to a method for water purification through fresh generation of a flocculant, and an apparatus applicable thereto.

### BACKGROUND

Water is a vital natural resource for survival of all organisms including human beings, and is also the most important part of an organism. Therefore, for the sake of health, more and more attention has been paid to water treatment.

The existing water purification process such as the tap water purification process usually includes the following steps.
Step 1: aluminum hydroxide and/or ferric hydroxide and/or ferrous hydroxide colloids are generated in water to be treated by a chemical reaction to settle suspended matters in the water, to achieve solid-liquid separation (SLS).
Step 2: unsettleable metal ions, organic matters, nitrogen and phosphorus compounds, etc are treated.
Step 3: a pH of the treated water is adjusted and/or the treated water is disinfected.

Since aluminum hydroxide, ferric hydroxide, and ferrous hydroxide all are insoluble in water, these inorganic compounds mostly cannot become colloids when directly added to water, and thus can hardly form flocs with suspended matters in the water for settlement, resulting in huge waste. Therefore, cost-effective aluminum salts and/or iron salts are usually used in the prior art for the chemical reaction in step 1. In this case, the salts are hydrolyzed under a corresponding pH to produce the hydroxide flocculated colloids to settle the suspended matters in the water for purification.

Principles of hydrolysis reactions of the aluminum salts and/or iron salts are shown in the following chemical reaction equations:

AlCl₃+3H₂O→Al(OH)₃+3HCl;

FeCl₃+3H₂O→Fe(OH)₃+3HCl;

2FeCl₂+5H₂O+[O]→2Fe(OH)₃+4HCl;

Al₂(SO₄)₃+6H₂O→2Al(OH)₃+3H₂SO₄;

Fe₂(SO₄)₃+6H₂O→2Fe(OH)₃+3H₂SO₄; and

2FeSO₄+5H₂O+[O]→2Fe(OH)₃+2H₂SO₄.

It can be seen from the above chemical reaction equations that the hydrolysis reactions of the aluminum salts and/or the iron salts inevitably result in the production of acids while leading to Al(OH)₃ and/or Fe(OH)₃ colloids. These acids cause chemical equilibrium systems of these hydrolysis reactions to shift left, and thus lead to incomplete hydrolysis of the aluminum salts and/or iron salts. In this case, a small amount of the aluminum salts and/or the iron salts enter the next water treatment procedure and are hydrolyzed in step 2 to produce colloids adhering to equipment, which affects a water treatment effect in step 2. In addition, in step 3, a larger amount of an alkaline oxidizing agent added to the treated water for disinfection means a larger amount of salt produced in the treated water. Therefore, water treated by the existing water purification process usually shows high acidity and high salt content. Long-term use of drinking water obtained through purification by this process will destroy an acid-base balance in a human body, which greatly increases a risk of cardiovascular diseases (CVDs), hypertension, and hyperlipidemia. Thus, the use of this process for recycling industrial water will directly affect a quality of a corresponding product.

In view of the above shortcomings, an ion-exchange resin (IER) and/or a reverse osmosis (RO) process are/is used in the prior art to remove salts and acidic compounds in water. However, due to strong selectivity of an IER and an RO membrane, a corresponding treatment device requires a complicated manufacturing process and a high management cost. In addition, when the treatment device is in operation, the IER and RO membrane need to be replaced frequently. Tens of thousands or even hundreds of thousands of RMB yuan are required for each replacement, resulting in an extremely high operating cost. Therefore, it is difficult to widely use the ion exchange and RO processes in actual production.

At present, there is no solution in which hydroxides can be freshly produced to purify water through flocculation without producing a salt or acid. Because a water purification process is related to the people's health and the eco-friendly recycling of industrial water resources, it is necessary to optimize the existing water purification process.

### SUMMARY

A first objective of the present disclosure is to provide a method for water purification through fresh generation of a flocculant. This method can effectively settle suspended matters in water and adsorb some organic impurities without producing acids and salts during fresh generation of hydroxides, which can ensure the water-drinking health and reduce the adverse effects of recycling of industrial water.

A second objective of the present disclosure is to provide an apparatus for water purification through flocculation, which is suitable for the method described above.

The first objective of the present disclosure is implemented by the following technical solutions:
A first method for water purification through fresh generation of a flocculant is provided, including the following steps:
(1) mixing a water-purifying agent precursor with a liquid, exciting a resulting mixture, and adding an excited mixture to water to be purified, so that the water-purifying agent precursor undergoes a reaction to produce ferric hydroxide and the ferric hydroxide co-settles with suspended matters and/or impurities in the water to be purified, where the exciting includes addition of an oxidizing substance; and
(2) subjecting a mixture obtained in step (1) to SLS to obtain purified water.

A second method for water purification through fresh generation of a flocculant is provided, including the following steps:
(1) mixing a water-purifying agent precursor directly with water to be purified, and exciting a resulting mixture, so that the water-purifying agent precursor undergoes a reaction to produce ferric hydroxide and the ferric hydroxide co-settles with suspended matters and/or impurities in the water to be purified,

where the exciting includes addition of an oxidizing substance; and
(2) subjecting a mixture obtained in step (1) to SLS to obtain purified water.

The above two methods can be conducted simultaneously. That is, while the water-purifying agent precursor and the liquid are mixed, excited, and then added to the water to be purified, the water-purifying agent precursor and the water to be purified are directly mixed and excited.

In step (1), the water-purifying agent precursor is ferrous carbonate and/or ferrous hydroxide; and the liquid is one or a combination of two or more selected from the group consisting of a water-purifying agent precursor aqueous solution, water, and the water to be purified, and the liquid is preferably water. When the liquid is a combination of two or more selected from the group consisting of the above components, a ratio of the two or more components is not limited.

When the liquid is the water to be purified, the water-purifying agent precursor may be mixed with a small amount of the water to be purified, and a resulting mixture is excited and then added to a large amount of the water to be purified; or the water-purifying agent precursor may be directly mixed with the water to be purified, and a resulting mixture is excited.

In the present disclosure, the water-purifying agent precursor is excited (specifically an oxidation reaction, or an oxidation reaction and an hydrolysis reaction) to freshly produce a ferric hydroxide colloid to settle suspended matters and/or impurities in the water; and a chemical reaction of the water-purifying agent precursor is described in detail below.

When the ferrous ion-containing water-purifying agent precursor is in contact with an oxidizing substance during excitation, ferrous ions are oxidized into ferric ions. When the water-purifying agent precursor includes ferrous carbonate, due to instability of ferric carbonate in water, ferrous carbonate is rapidly oxidized and hydrolyzed in water to produce ferric hydroxide and release carbon dioxide while in contact with an oxidizing substance during excitation, as shown in Equation 1. When the water-purifying agent precursor is ferrous hydroxide, the water-purifying agent precursor rapidly reacts with an oxidizing substance and is oxidized into ferric hydroxide during excitation, and no carbon dioxide is generated during the reaction, which is more eco-friendly, as shown in Equation 2:

4FeCO₃+6H₂O+2[O]→4Fe(OH)₃+4CO₂⬆Equation 1; and

2Fe(OH)₂+H₂O+[O]→2Fe(OH)₃Equation 2.

It can be seen from the above chemical reaction equations that the method of the present disclosure can allow the fresh generation of ferric hydroxide from the water-purifying agent precursor, and a water purification process in which by-products such as acids or salts are not produced is created. This can provide a flocculation-based water purification effect, avoid adverse impacts of acids and salts on the human health and the recycling of industrial water, and reduce a cost of by-product treatment.

In addition, the exciting in step (1) of the present disclosure includes addition of an oxidizing substance to produce ferric hydroxide, so that organic matters can be adsorbed based on the characteristic of ferric ions to adsorb anions, which can well reduce a COD value in treated water.

In step (1), the oxidizing substance is one or a combination of two or more selected from the group consisting of oxygen, air, ozone, and hydrogen peroxide. When the oxidizing substance is a combination of two or more selected from the group consisting of the above components, a ratio of the two or more components is not limited.

Preferably, the oxidizing substance is oxygen and/or air.

As a further implementation of the present disclosure, in step (1), when the oxidizing substance includes at least one gaseous oxidizing substance selected from the group consisting of oxygen, air, and ozone, the at least one gaseous oxidizing substance is added to the mixture of the water-purifying agent precursor and the liquid in at least one manner selected from the group consisting of jetting, spraying, pumping, aeration, and liquid injection. The liquid injection manner is specifically as follows: injecting the mixture of the water-purifying agent precursor and the liquid to a high place based on a pressure, so that the mixture falls to the water to be purified or to the mixture of the water-purifying agent precursor and the water to be purified through a gaseous oxidizing substance-containing environment; or injecting the mixture of the water-purifying agent precursor and the liquid together with the at least one oxidizing substance to a high place based on a pressure, so that the mixture falls to the water to be purified or to the mixture of the water-purifying agent precursor and the water to be purified through a gaseous oxidizing substance-containing environment, where during a process of falling from the high place to the water to be purified, the mixture fully contacts the at least one gaseous oxidizing substance to allow an oxidation reaction of the water-purifying agent precursor.

Preferably, in the present disclosure, in step (1), when the oxidizing substance includes air, air is added through aeration and/or liquid injection. More preferably, in the present disclosure, in step (1), when the oxidizing substance includes air, air is added through liquid injection, which facilitates the contact of the mixture of the water-purifying agent precursor and the liquid with air to rapidly excite the water-purifying agent precursor.

As a further implementation of the present disclosure, in step (1), the exciting is a combination of the addition of the oxidizing substance with one or more selected from the group consisting of heating and ultrasonic oscillation.

When the water-purifying agent precursor is in contact with water and an oxidizing substance under heating or ultrasonic oscillation, the hydrolysis of the water-purifying agent precursor is promoted to produce a hydroxide. Ultrasonic waves in a liquid can produce cavitation bubbles that can absorb sound wave energy and collapse in a very short time to release energy. When the cavitation bubbles collapse in a very small surrounding space, a high temperature and a high pressure can be produced to promote a hydrolysis reaction and an oxidation reaction of the water-purifying agent precursor.

When the water-purifying agent precursor includes ferrous carbonate, under heating or ultrasonic oscillation, ferrous carbonate may undergo the following hydrolysis reaction to produce ferrous hydroxide when not in contact with an oxidizing substance, as shown in Equation 3:

FeCO₃+H₂O→Fe(OH)₂+CO₂⬆ Equation 3.

The present disclosure may be improved as follows: In step (1), there are less than or equal to 300 g of iron from ferrous carbonate as a water-purifying agent precursor and less than or equal to 500 g of iron from ferrous hydroxide as a water-purifying agent precursor in each liter of the water to be purified.

Since iron ions exist in a form of hydrated ions in a solution, ferrous carbonate as the water-purifying agent precursor will absorb a large amount of water when undergoing a reaction to produce a hydroxide. When there is more than 300 g of iron from ferrous carbonate as a water-purifying agent precursor in each liter of the water to be purified, a large amount of water will be absorbed, and a flocculated sediment has a large volume, which increases the difficulty of SLS and the treatment cost. When there is more than 500 g of iron from ferrous hydroxide as a water-purifying agent precursor in each liter of the water to be purified, a flocculated sediment has a large volume, resulting in a high treatment cost.

The present disclosure may be improved as follows: In step (1), there is more than or equal to 0.002 g of iron from the water-purifying agent precursor in each liter of the water to be purified.

The inventors have found through multiple sets of experiments that, when there is no less than 0.002 g of iron from the water-purifying agent precursor in each liter of the water to be purified, suspended matters and/or impurities in the water to be purified can be well flocculated and settled.

The present disclosure may be improved as follows: In step (1), a pH of the water to be purified is higher than or equal to 2 to allow for a satisfactory flocculation effect. When a pH of a solution environment is lower than 2, there is a significant amount of acids in the solution environment, so that a hydroxide generated from the water-purifying agent precursor will partially react with the acids to convert to soluble salts, which reduces an amount of a flocculated colloid, thereby affecting a flocculation-based water purification effect.

The second objective of the present disclosure is implemented by the following technical solutions:

A first apparatus for water purification through flocculation is provided, including a flocculation sedimentation tank, where an oxidizing substance-feeding device is further provided, and the oxidizing substance-feeding device is provided with at least one selected from the group consisting of a liquid oxidizing substance outlet, a gaseous oxidizing substance outlet, and a liquid outlet; and the oxidizing substance-feeding device connects to or is arranged in the flocculation sedimentation tank, and is configured to feed an oxidizing substance into the flocculation sedimentation tank.

A second apparatus for water purification through flocculation is provided, including a flocculation sedimentation tank, where a water-purifying agent precursor excitation tank is further provided to form a combination with the flocculation sedimentation tank;

the water-purifying agent precursor excitation tank is configured to excite a water-purifying agent precursor;

an oxidizing substance-feeding device is provided for the water-purifying agent precursor excitation tank or an oxidizing substance-feeding device is provided for both the flocculation sedimentation tank and the water-purifying agent precursor excitation tank; the oxidizing substance-feeding device connects to or is arranged in the corresponding water-purifying agent precursor excitation tank and/or flocculation sedimentation tank, and is configured to feed an oxidizing substance into the water-purifying agent precursor excitation tank and/or the flocculation sedimentation tank; the oxidizing substance-feeding device is provided with at least one selected from the group consisting of a liquid oxidizing substance outlet, a gaseous oxidizing substance outlet, and a liquid outlet; and

a liquid outlet of the water-purifying agent precursor excitation tank is connected to the flocculation sedimentation tank through a pipeline, or the liquid outlet of the oxidizing substance-feeding device arranged in the water-purifying agent precursor excitation tank faces towards the flocculation sedimentation tank, so that a liquid flow is directed into the flocculation sedimentation tank.

The oxidizing substance-feeding device can be a liquid oxidizing substance-feeding device composed of a temporary storage tank and a pump, or a gas-liquid mixing device configured to mix a gaseous oxidizing substance with a mixture of a water-purifying agent precursor and a liquid. The gas-liquid mixing device may be at least one selected from the group consisting of a gas-liquid mixing jetting device (venturi tube), a liquid spraying absorption tower, a pumping device, an aeration device, and a liquid injection device.

The liquid oxidizing substance-feeding device is provided with a liquid oxidizing substance outlet, the pumping device as the gas-liquid mixing device is provided with a gaseous oxidizing substance outlet, the gas-liquid mixing jetting device (venturi tube) and the liquid spraying absorption tower as the gas-liquid mixing device each are provided with a liquid outlet, the aeration device as the gas-liquid mixing device is provided with a gaseous oxidizing substance outlet or a liquid outlet, and the liquid injection device as the gas-liquid mixing device is provided with a liquid outlet. An effluent from the liquid outlet is a liquid including the water-purifying agent precursor and/or ferric hydroxide freshly generated, or a mixture of the liquid with at least one oxidizing substance. The pumping device is a combination of a gas pump/compressed gas source with a connection pipeline. The liquid injection device is a combination of a nozzle with a pipeline having a pump and/or a compressed gas source, where the nozzle is a liquid outlet; and a mixture of a water-purifying agent precursor and a liquid is injected to a gaseous oxidizing substance-containing environment through the combination of the nozzle with the pump and/or the compressed gas source to allow a chemical reaction.

Further, the flocculation sedimentation tank and/or the water-purifying agent precursor excitation tank are/is further provided with at least one selected from the group consisting of a heat exchange device and an ultrasonic generator.

The ultrasonic generator is a fixed ultrasonic generator integrated with the flocculation sedimentation tank or the water-purifying agent precursor excitation tank, or a discrete and movable ultrasonic generator independent of the flocculation sedimentation tank and/or the water-purifying agent precursor excitation tank.

The present disclosure may be improved as follows: A sediment tank is further provided at a bottom of the flocculation sedimentation tank, and the flocculation sedimentation tank is provided with a discharge port higher than the sediment tank. This arrangement can allow purified water to be separated from flocculated impurities through standing and then flow out from the flocculation sedimentation tank, so that purified water with a low impurity content can be obtained. The sediment tank has an inverted cone structure, and a discharge port is formed at a lowermost bottom of the sediment tank.

The present disclosure may be improved as follows: A stirring device is further provided in the flocculation sedimentation tank and/or the water-purifying agent precursor excitation tank, and is configured to make a water-purifying agent precursor and/or a hydroxide produced therefrom thoroughly mixed with water to be purified. The stirring device is specifically one or more selected from the group consisting of a paddle stirring device and a pump-tubular liquid circulator.

The present disclosure may be improved as follows: An SLS device is further provided, and the SLS device is connected to the discharge port of the flocculation sedimentation tank and is configured to allow SLS of a mixture in the flocculation sedimentation tank. The SLS device is selected from the group consisting of a press filter, a filter, a centrifuge, and an inclined pipe sedimentation tank.

The present disclosure may be improved as follows: A temporary storage tank is further provided; the temporary storage tank is directly connected to the flocculation sedimentation tank and/or the water-purifying agent precursor excitation tank and/or the SLS device, or is connected to the flocculation sedimentation tank and/or the water-purifying agent precursor excitation tank and/or the SLS device through a pump or a solid feeder; and the temporary storage tank is configured to load materials to be involved in water purification, or to temporarily store materials during or after a water purification process.

The present disclosure may be improved as follows: A process data detection device is arranged in the flocculation sedimentation tank and/or the water-purifying agent precursor excitation tank. The process data detection device includes at least one selected from the group consisting of a liquid-level meter, a specific gravity meter, a viscometer, a turbidimeter, a pH meter, a conductivity meter, an oxidation-reduction potential (ORP) meter, a flow meter, a Tyndall effect detection device, and a chemical oxygen demand (COD) detector. A viscometer detection device and/or a Tyndall effect detection device are/is further provided in the flocculation sedimentation tank and/or the water-purifying agent precursor excitation tank to detect the generation of a hydroxide on-line. It is ensured through results measured by the process data detection device that the water-purifying agent precursor can be effectively converted into a hydroxide, which allows the full utilization of the water-purifying agent precursor.

The present disclosure may be improved as follows: The process data detection device and an automatic detection and feeding controller are arranged in the flocculation sedimentation tank and/or the water-purifying agent precursor excitation tank, and the automatic detection and feeding controller is configured to receive data of the process data detection device and automatically control an operation of the apparatus for water purification through flocculation according to the data.

Compared with the prior art, the present disclosure has the following beneficial effects:
1. In the present disclosure, the water-purifying agent precursor is excited to undergo an oxidation reaction and/or a hydrolysis reaction to freshly produce a hydroxide colloid for flocculation-based water purification. During the reaction(s), by-products such as acids or salts are not produced, which solves the problem of the existing water purification process that acids or salts will be produced due to fresh generation of a hydroxide, and avoids or reduces the use of IER and/or RO devices for neutralization and desalination, thereby largely reducing the high equipment investment funds and the high equipment maintenance and management costs.
2. In the present disclosure, a hydroxide colloid is freshly generated through a hydrolysis reaction and/or an oxidation reaction of the water-purifying agent precursor to allow flocculation-based water purification. Thus in the subsequent water purification procedure, there is no need to additionally add sodium hydroxide solution to neutralize an acid produced during generation of a hydroxide. There is also no need to frequently replace device accessories to which a colloid produced from hydrolysis of unhydrolyzed aluminum salts and/or iron salts entering the water treatment procedure adheres, and the process conversion will not cause an increase in a production cost.
3. In the present disclosure, no acids and salts are produced due to a hydrolysis reaction for freshly producing a hydroxide, which improves the quality of purified water, enhances the physical health of people, and reduces the devices used for recycling of industrial water.
4. The method of the present disclosure does not lead to new pollution sources, and has a low water purification cost.

### BRIEF DESCRIPTION OF THE DRAWINGS

The present disclosure is further described below with reference to accompanying drawings.

FIG. 1 shows the apparatus for water purification through flocculation used in Example 1;

FIG. 2 shows the apparatus for water purification through flocculation used in Example 2;

FIG. 3 shows the apparatus for water purification through flocculation used in Example 3;

FIG. 4 shows the apparatus for water purification through flocculation used in Example 4;

FIG. 5 shows the apparatus for water purification through flocculation used in Example 5; and

FIG. 6 shows the apparatus for water purification through flocculation used in Example 6.

Reference numerals: 1: flocculation sedimentation tank; 2: water-purifying agent precursor excitation tank; 3: heat exchange device; 4-5: ultrasonic generator; 6-8: oxidizing substance-feeding device; 10: sediment tank; 11: stirring device; 14: SLS device; 15-17: temporary storage tank; 19-23: process data detection device; 24: automatic detection and feeding controller; 25-28: pump; 29: compressed gas source; 40-41: valve; 50-51: discharge port; 55: solid feeder; 56-57: water-purifying agent precursor; 60: water to be purified; 61: purified water; 62-63: oxidizing substance; 67: flocculated sediment; 69: solid sodium hydroxide; 70: ozone generator; and 71: water.

### DETAILED DESCRIPTION

The present disclosure is further described below through specific examples.

In the following examples, the flocculation sedimentation tank, the water-purifying agent precursor excitation tank, the paddle stirring device, and the pump-tubular liquid circulator all are manufactured by Guangdong Foshan Yegao Environmental Protection Equipment Manufacturing Co., Ltd. The ultrasonic generator is a commercially-available product, the ferrous hydroxide, ferrous carbonate, hydrogen peroxide, and oxygen are commercially-available products, and the ozone generator, the test instruments, and the automatic detection and feeding controller are commercially-available products. Other products with similar properties to the products listed above in the present disclosure may also be adopted by those skilled in the art according to conventional selection, which all can achieve the objectives of the present disclosure.

### Test of a Treatment Effect of COD in Water to be Purified

A standard organic solution with a COD value of 500 ppm was prepared with potassium hydrogen phthalate (KHP), and based on the standard organic solution, a COD value in purified water obtained after 1 ton of water to be purified was purified through flocculation and settlement was determined.

### Verification Test of a Flocculated Colloid in Purified Water

A hydroxide is freshly generated from the water-purifying agent precursor and then mixed with 1 ton of water to be purified for co-sedimentation. Then resulting purified water is tested for a purification effect by a turbidimeter and/or through irradiation by a concentrated light source. Specifically, the purification effect is determined by comparing determination results of the turbidimeter before and after water purification; or the purification effect is determined by observing a bright path of purified water in a direction of vertical incident light, if a Tyndall effect occurs, it indicates the presence of a colloid.

### Example 1

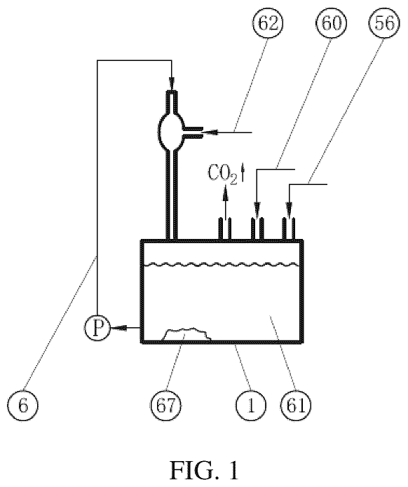

As shown in FIG. 1, an apparatus for water purification through flocculation is provided in this example, including a flocculation sedimentation tank 1. The flocculation sedimentation tank 1 is provided with an oxidizing substance-feeding device 6. The oxidizing substance-feeding device 6 is a gas-liquid mixing device and specifically a gas-liquid mixing jetting device, and a gas-liquid mixture outlet is formed in the flocculation sedimentation tank 1.

In this example, an oxidizing substance 62 is oxygen. A water-purifying agent precursor 56 is a mixture of ferrous carbonate and ferrous hydroxide, and is fed to the flocculation sedimentation tank 1 through a feed port.

A method for water purification through fresh generation of a flocculant is provided, including the following steps:
1. The apparatus for water purification through flocculation was arranged as shown in FIG. 1, and the water-purifying agent precursor was mixed with water to be purified in the flocculation sedimentation tank 1 according to the amounts shown in Table 1.
2. The oxidizing substance-feeding device 6 was started, and the water-purifying agent precursor in the flocculation sedimentation tank 1 was excited by oxygen as an oxidizing substance, so that the water-purifying agent precursor underwent a reaction to produce ferric hydroxide and the ferric hydroxide co-settled with suspended matters and/or impurities in the water to be purified to obtain purified water.

In Example 1, a pH of the water to be purified 60 was 7, and the water-purifying agent precursor was a mixture of ferrous carbonate and ferrous hydroxide. It was tested that an amount of ferric iron of ferric hydroxide generated in each liter of the water to be purified in this example was 100 g, and no acid or salt was freshly produced due to the water-purifying agent precursor. Data of a water purification effect in this example was listed in Table 1.

### Example 2

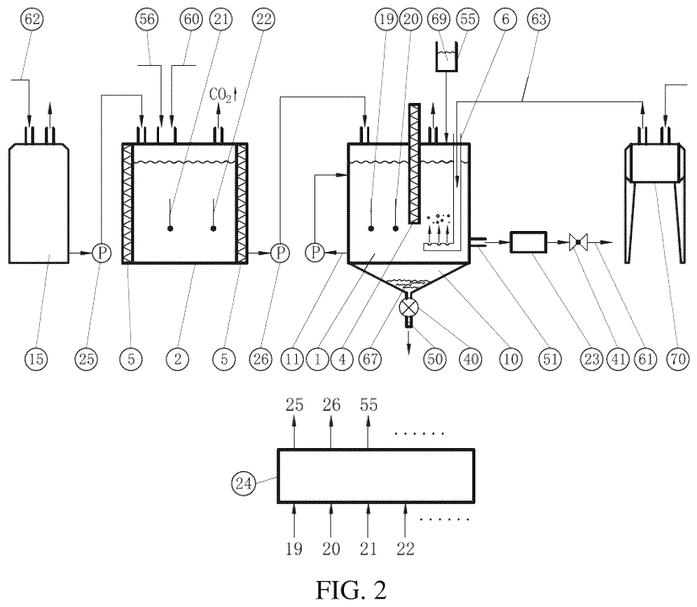

As shown in FIG. 2, an apparatus for water purification through flocculation is provided in this example, including a flocculation sedimentation tank 1, a water-purifying agent precursor excitation tank 2, ultrasonic generators 4 and 5, an oxidizing substance-feeding device 6, process data detection devices 19 to 23, an automatic detection and feeding controller 24, a temporary storage tank 15, a solid feeder 55, and an ozone generator 70.

A liquid outlet of the water-purifying agent precursor excitation tank 2 is connected to the flocculation sedimentation tank 1 through a pipeline having a pump 26, so that a liquid flow can be directed into the flocculation sedimentation tank 1.

The flocculation sedimentation tank 1 is provided with a movable ultrasonic generator 4, process data detection devices 19 and 20 (specifically a pH meter and a liquid-level meter), a stirring device 11 (which is specifically a pump-tubular liquid circulator), and an oxidizing substance-feeding device 6. The oxidizing substance-feeding device 6 is a bubbling pumping device, which is connected to the ozone generator configured to feed ozone into the flocculation sedimentation tank 1. The flocculation sedimentation tank 1 is connected to a solid feeder 55, and the solid feeder is configured to feed solid sodium hydroxide to adjust a pH of purified water. A discharge port 51 at a lower part of the flocculation sedimentation tank 1 is connected to a COD detector 23, and the COD detector is configured to sample and test water. A sediment tank 10 is provided at a bottom of the flocculation sedimentation tank 1, and a valve 40 and a discharge port 50 are provided at a lowermost bottom of the sediment tank.

The water-purifying agent precursor excitation tank 2 is provided with a fixed ultrasonic generator 5 and process data detection devices 21 and 22 (specifically an ORP meter and a viscometer) in an integrated manner.

In the water-purifying agent precursor excitation tank 2, the ultrasonic generator 5 is started to oxidize a mixture of water to be purified 60 and a water-purifying agent precursor 56. The water-purifying agent precursor excitation tank 2 is connected to an oxidizing substance-feeding device composed of a temporary storage tank 15 and a pump 25.

The automatic detection and feeding controller 24 is configured to control the pump 25 to feed an oxidizing substance into the water-purifying agent precursor excitation tank 2 and control the start and stop of the ultrasonic generator 5 according to results determined by the process data detection device 21 (an ORP meter). According to results determined by the process data detection device 22 (a viscometer) and the process data detection device 20 (a liquid-level meter), the pump 26 is controlled to feed a mixture in the water-purifying agent precursor excitation tank 2 into the flocculation sedimentation tank 1; and according to results determined by the process data detection device 19 (a pH meter), the solid feeder 55 is controlled to feed an inorganic base into the flocculation sedimentation tank 1 to adjust a pH of a liquid in the tank.

In this example, the oxidizing substance 62 added to the temporary storage tank 15 is hydrogen peroxide, and the oxidizing substance 63 added to the flocculation sedimentation tank 1 is ozone; the water to be purified 60 is industrial acid-containing water with a pH of 0.2; and the water-purifying agent precursor 56 is ferrous carbonate.

A method for water purification through fresh generation of a flocculant is provided, including following steps:
1. The apparatus for water purification through flocculation was arranged as shown in FIG. 2, and the water-purifying agent precursor 56 and the water to be purified 60 were mixed in the water-purifying agent precursor excitation tank 2 according to the amounts shown in Table 1.
2. The oxidizing substance 62 was fed into the temporary storage tank 15, the pump 25 was turned on, and the ultrasonic generator 5 was started, so that the water-purifying agent precursor 56 in the water-purifying agent precursor excitation tank 2 was excited with hydrogen peroxide as an oxidizing substance under ultrasonic oscillation to undergo a reaction to produce a hydroxide. When data of the ORP meter and the viscometer of the water-purifying agent precursor excitation tank 2 reached set values, the pump 25, the ultrasonic generator 5, and all feeding devices were stopped.
3. According to on-site test data of the process data detection devices 21, 22, and 19, the pump 26 was controlled to feed a solution in the water-purifying agent precursor excitation tank 2 into the flocculation sedimentation tank 1.
4. The solid feeder 55 was started to feed sodium hydroxide into the flocculation sedimentation tank 1 to adjust a pH of a solution in the tank to 5, and the ultrasonic generator 4, the ozone generator 70, and the oxidizing substance-feeding device 6 were simultaneously started to introduce ozone into the solution in the flocculation sedimentation tank 1. The unreacted water-purifying agent precursor and the generated ferrous hydroxide were further excited with ozone as an oxidizing substance under ultrasonic oscillation, so that the water-purifying agent precursor underwent a complete reaction and ferric hydroxide was produced and co-settled with suspended matters and/or impurities in the water to be purified.
5. The valve 41 was turned on to drain purified water 61 in the flocculation sedimentation tank 1, the purified water was sampled and tested by the COD detector to determine a COD value, and a sediment 67 in the sediment tank 10 was collected for further treatment.

In this example, a pH of the water to be purified 60 was 0.2, the water-purifying agent precursor 56 was ferrous carbonate, and a pH of the purified water was 5. It was tested that an amount of ferric iron of ferric hydroxide generated in each liter of the water to be purified in this example was 10 g, and no acid or salt was freshly produced due to the water-purifying agent precursor. Data of a water purification effect in this example was listed in Table 1.

### Example 3

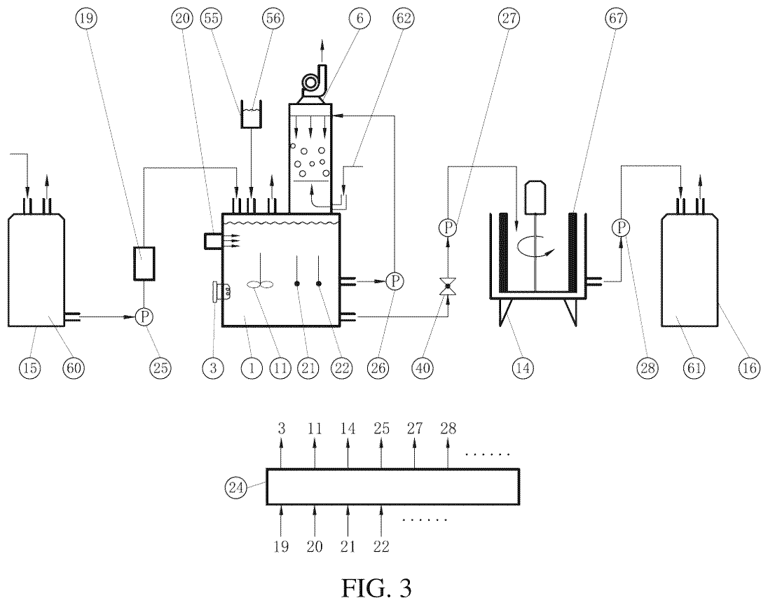

As shown in FIG. 3, an apparatus for water purification through flocculation is provided in this example, including a flocculation sedimentation tank 1, a temporary storage tank 15, an oxidizing substance-feeding device 6, an SLS device 14, and an automatic detection and feeding controller 24.

The flocculation sedimentation tank 1 is provided with a heat exchange device 3, an oxidizing substance-feeding device 6, a stirring device 11, and process data detection devices 20 to 22. The oxidizing substance-feeding device 6 is a gas-liquid mixing device and is specifically a liquid spraying absorption tower, an oxidizing substance used is air, and a gas-liquid mixture outlet of the oxidizing substance-feeding device is connected to the flocculation sedimentation tank 1. The stirring device 11 is a paddle stirring device; and the process data detection devices 20 to 22 are a Tyndall effect detection device, a conductivity meter, and a thermometer, respectively. The flocculation sedimentation tank 1 is connected to a solid feeder 55, and the solid feeder is configured to feed a water-purifying agent precursor 56.

The temporary storage tank 15 is filled with water to be purified 60, and is connected to the flocculation sedimentation tank 1 through a pipeline having a process data detection device 19 (specifically a flow meter) and a pump 25.

The SLS device 14 is a centrifuge connected to a discharge port of the flocculation sedimentation tank 1 through a valve 40 and a pump 27, and a filtrate outlet of the centrifuge is connected to the temporary storage tank 16.

In this example, the automatic detection and feeding controller 24 controls the pump 25 to feed water to be purified 60 into the flocculation sedimentation tank 1 according to results determined by the process data detection device 19, and to control the start and stop of the heat exchange device 3 and adjust a size of a heat exchange according to a treatment status of the water to be purified 60 determined by the process data detection devices 20 and 21 and results determined by the process data detection device 22.

The water-purifying agent precursor 56 used in this example is a ferrous hydroxide solid.

A method for water purification through fresh generation of a flocculant is provided, including following steps:
1. The apparatus for water purification through flocculation was arranged as shown in FIG. 3, and the water-purifying agent precursor 56 was mixed with the water to be purified 60 in the flocculation sedimentation tank 1 according to the amounts shown in Table 1.
2. The oxidizing substance-feeding device 6 and the heat exchange device 3 were started, and the water-purifying agent precursor 56 in the flocculation sedimentation tank 1 was excited by air as an oxidizing substance under heating, so that the water-purifying agent precursor 56 underwent a reaction to produce ferric hydroxide and the ferric hydroxide co-settled with suspended matters and/or impurities in the water to be purified 60.
3. A mixture in the flocculation sedimentation tank 1 was subjected to SLS by the SLS device 14 (the centrifuge) to obtain purified water 61, and the purified water was temporarily stored in the temporary storage tank 16.

In this example, a pH of the water to be purified 60 was 5, and the water-purifying agent precursor was ferrous hydroxide. It was tested that an amount of ferric iron of ferric hydroxide generated in each liter of the water to be purified in this example was 500 g, and no acid or salt was freshly produced due to the water-purifying agent precursor. Data of a water purification effect in this example was listed in Table 1.

### Example 4

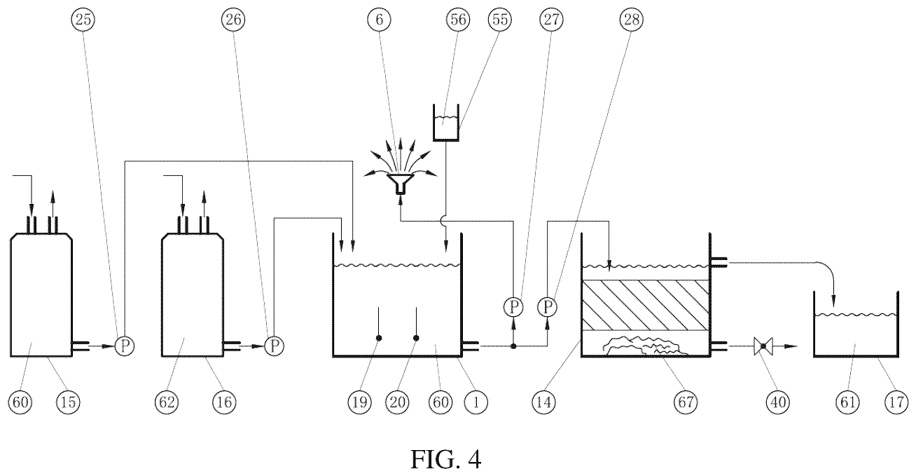

As shown in FIG. 4, an apparatus for water purification through flocculation is provided in this example, including a flocculation sedimentation tank 1, where the flocculation sedimentation tank 1 is provided with an oxidizing substance-feeding device 6 and process data detection devices 19 and 20; the oxidizing substance-feeding device 6 is a gas-liquid mixing device and is specifically a liquid injection device, and water to be purified 60 is injected into the air to undergo a chemical reaction with oxygen in the air through a combination of a pump 27 with a nozzle (the nozzle is a liquid outlet), where the air here is the oxidizing substance-containing environment described above; and the process data detection devices 19 and 20 are a turbidimeter and a liquid-level meter, respectively.

The flocculation sedimentation tank 1 is further connected to an oxidizing substance-feeding device composed of a temporary storage tank 16 and a pump 26, an oxidizing substance 62 (specifically hydrogen peroxide) is fed into the flocculation sedimentation tank 1 to allow an auxiliary oxidation reaction of a water-purifying agent precursor 56, that is, the apparatus of the present disclosure has two oxidizing substance-feeding devices.

The flocculation sedimentation tank 1 is connected to a solid feeder 55, and the solid feeder is configured to feed a water-purifying agent precursor 56; and the flocculation sedimentation tank further communicates with a temporary storage tank 15 through a pump 25 to drain water to be purified 60.

An SLS device 14 is an inclined pipe sedimentation tank communicating with a discharge port of the flocculation sedimentation tank 1 through a pump 28. A discharge port of the SLS device 14 is connected to the temporary storage tank 17, and the temporary storage tank is configured to store purified water 61.

The water-purifying agent precursor 56 used in this example is a ferrous carbonate solid.

A method for water purification through fresh generation of a flocculant is provided, including following steps:
1. The apparatus for water purification through flocculation was arranged as shown in FIG. 4, and the water-purifying agent precursor 56 was mixed with the water to be purified 60 in the flocculation sedimentation tank 1 according to the amounts shown in Table 1.
2. The oxidizing substance-feeding device 6 and the pump 26 were started, and the water-purifying agent precursor 56 in the flocculation sedimentation tank 1 was excited by air and hydrogen peroxide as oxidizing substances, so that the water-purifying agent precursor 56 underwent a reaction to produce ferric hydroxide and release carbon dioxide and the produced colloid co-settled with suspended matters and/or impurities in the water to be purified 60.
3. A mixture in the flocculation sedimentation tank 1 was drained to the SLS device 14 and subjected to SLS to obtain purified water 61, and the purified water was temporarily stored in the temporary storage tank 17.

In this example, the water to be purified 60 was suspended impurity-containing water with a pH of 8, the water-purifying agent precursor was ferrous carbonate, and the oxidizing substances were oxygen in the air and hydrogen peroxide. It was tested that an amount of ferric iron of ferric hydroxide generated in each liter of the water to be purified in this example was 300 g, and no acid or salt was freshly produced due to the water-purifying agent precursor. Data of a water purification effect in this example was listed in Table 1.

### Example 5

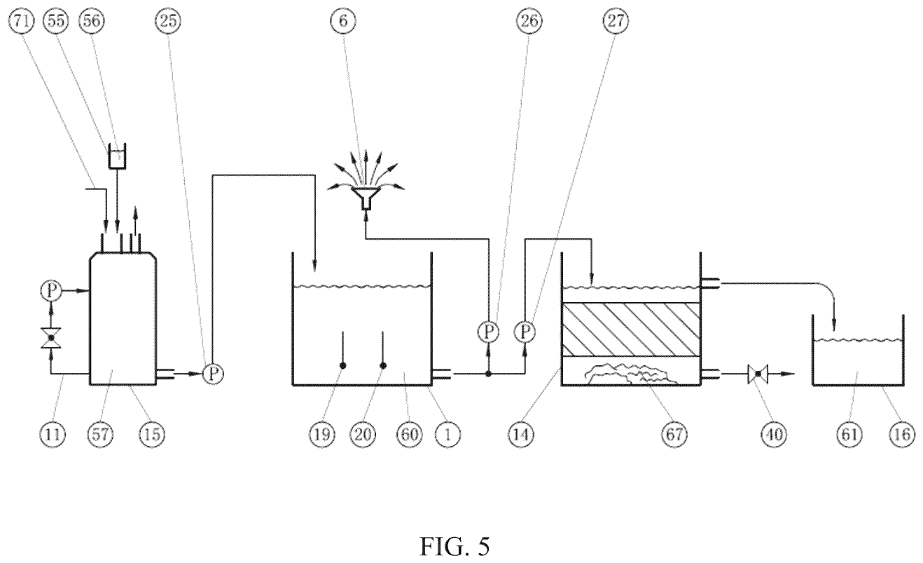

As shown in FIG. 5, an apparatus for water purification through flocculation is provided in this example, including a flocculation sedimentation tank 1, an oxidizing substance-feeding device 6, a stirring device 11, an SLS device 14, and temporary storage tanks 15 and 16.

The flocculation sedimentation tank 1 is provided with an oxidizing substance-feeding device 6 and process data detection devices 19 and 20. The oxidizing substance-feeding device 6 is a gas-liquid mixing device and is specifically a liquid injection device, and water to be purified 60 is injected into the air to undergo an oxygen reaction with oxygen in the air through a combination of a pump 26 with a nozzle (the nozzle is a liquid outlet), where the air here is the oxidizing substance-containing environment described above, which makes a water-purifying agent precursor oxidized to produce a ferric hydroxide colloid; and the process data detection devices 19 and 20 are a turbidimeter and a liquid-level meter, respectively.

The temporary storage tank 15 is configured to prepare a water-purifying agent precursor 57 with water 71, and the temporary storage tank is provided with the stirring device 11 (specifically a pump-tubular liquid circulator) and is connected to a solid feeder 55 configured to feed a water-purifying agent precursor 56. A discharge port of the temporary storage tank 15 communicates with the flocculation sedimentation tank 1 through a pump 25.

The SLS device 14 is an inclined pipe sedimentation tank connected to a discharge port of the flocculation sedimentation tank 1 through a pump 27. A discharge port of the SLS device 14 is connected to the temporary storage tank 16, and the temporary storage tank is configured to store purified water 61.

The water-purifying agent precursor 56 used in this example is a ferrous hydroxide solid.

A method for water purification through fresh generation of a flocculant is provided, including following steps:
1. The apparatus for water purification through flocculation was arranged as shown in FIG. 5, water 71 was fed into the temporary storage tank 15, and the solid feeder 55 was started to feed ferrous hydroxide 56 to prepare the water-purifying agent precursor 57, that is, a ferrous hydroxide solution.
2. water to be purified 60 was fed into the flocculation sedimentation tank 1, and the water-purifying agent precursor 57 was mixed with the water to be purified 60 in the flocculation sedimentation tank 1 according to the amounts shown in Table 1.
3. The oxidizing substance-feeding device 6 was started, and the water-purifying agent precursor 57 in the flocculation sedimentation tank 1 was excited by air as an oxidizing substance, so that the water-purifying agent precursor 57 underwent a reaction to produce a ferric hydroxide colloid and the ferric hydroxide colloid co-settled with suspended matters and/or impurities in the water to be purified 60.
4. A mixture in the flocculation sedimentation tank 1 was drained to the SLS device 14 and subjected to SLS to obtain purified water 61, and the purified water was temporarily stored in the temporary storage tank 16.

In this example, the water to be purified 60 was suspended impurity-containing water with a pH of 6.9, and the water-purifying agent precursor was a ferrous hydroxide liquid. It was tested that an amount of ferric iron of ferric hydroxide generated in each liter of the water to be purified in this example was 0.002 g, and no acid or salt was freshly produced due to the water-purifying agent precursor. Data of a water purification effect in this example was listed in Table 1. The solution in this example involves simple devices and operations and does not lead to the generation of carbon dioxide and other impurities, and thus the solution can be used as a purification solution for municipal tap water.

### Example 6

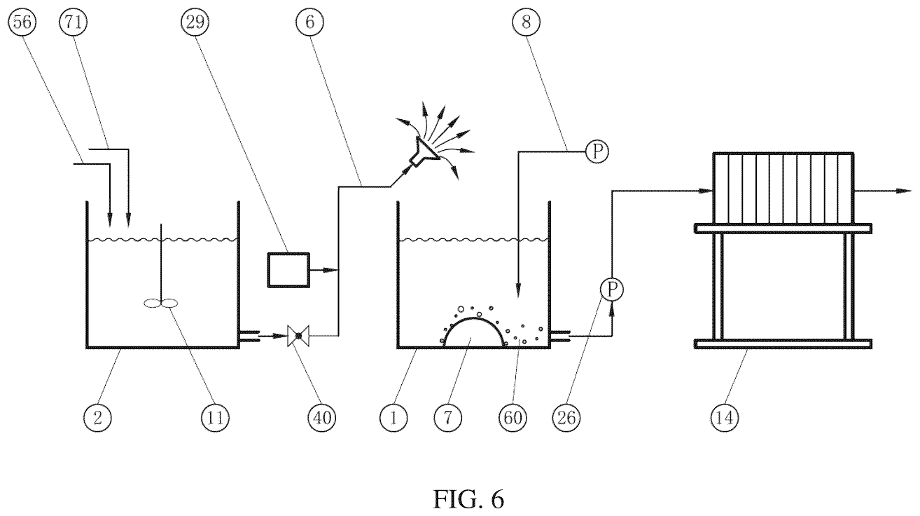

As shown in FIG. 6, an apparatus for water purification through flocculation is provided in this example, including a flocculation sedimentation tank 1, a water-purifying agent precursor excitation tank 2, an oxidizing substance-feeding device 6, an oxidizing substance-feeding device 7, an oxidizing substance-feeding device 8, a stirring device 11, and an SLS device 14.

The water-purifying agent precursor excitation tank 2 is provided with an oxidizing substance-feeding device 6 and a stirring device 11 (specifically a paddle stirring device). The oxidizing substance-feeding device 6 is a gas-liquid mixing device and is specifically a liquid injection device, which is provided with a nozzle (namely, a liquid outlet) facing towards the flocculation sedimentation tank 1; a mixture of a water-purifying agent precursor 56 and water 71 is injected into the air to undergo an oxidation reaction with oxygen in the air through a combination of a compressed gas source 29 with the nozzle, where the air here is the oxidizing substance-containing environment described above, a liquid flow is directed into the flocculation sedimentation tank 1, and the compressed gas source 29 is specifically a high-pressure gas tank filled with compressed air.

The flocculation sedimentation tank 1 is provided with an oxidizing substance-feeding device 7 and an oxidizing substance-feeding device 8. The oxidizing substance-feeding device 7 is a gas-liquid mixing device and is specifically an aeration device, and the aeration device is provided with a gaseous oxidizing substance outlet and is configured to forcibly add air to water to be purified 60. The oxidizing substance-feeding device 8 is a gas-liquid mixing device and is specifically a pumping device, and the pumping device is composed of a gas pump and a connection channel and is configured to add air to water to be purified 60. The oxidizing substance-feeding device 7 and the oxidizing substance-feeding device 8 make the unreacted water-purifying agent precursor in the flocculation sedimentation tank 1 oxidized by oxygen in the air to produce a ferric hydroxide colloid.

The SLS device 14 is a press filter connected to a discharge port of the flocculation sedimentation tank 1 through a pump 26.

The water-purifying agent precursor 56 used in this example is a ferrous carbonate solid.

A method for water purification through fresh generation of a flocculant is provided, including following steps:
1. The apparatus for water purification through flocculation was arranged as shown in FIG. 6, and water 71 and a water-purifying agent precursor ferrous carbonate 56 were fed into the water-purifying agent precursor excitation tank 2.
2. water to be purified 60 was fed into the flocculation sedimentation tank 1.
3. The water-purifying agent precursor 56 was fed into the water-purifying agent precursor excitation tank 2 according to the amount shown in Table 1, and the oxidizing substance-feeding device 6 was started, so that the water-purifying agent precursor 56 was excited by air as an oxidizing substance and a liquid flow was directed into the flocculation sedimentation tank 1; the oxidizing substance-feeding device 7 and the oxidizing substance-feeding device 8 were started, so that the unreacted water-purifying agent precursor 56 in the flocculation sedimentation tank 1 was excited; and the water-purifying agent precursor 56 underwent a reaction to produce a ferric hydroxide colloid and the ferric hydroxide colloid co-settled with suspended matters and/or impurities in the water to be purified 60.
4. A mixture in the flocculation sedimentation tank 1 was drained to the SLS device 14 and subjected to SLS to obtain purified water 61.

In this example, the water to be purified 60 was suspended impurity-containing water with a pH of 7, and the water-purifying agent precursor was ferrous carbonate. It was tested that an amount of ferric iron of ferric hydroxide generated in each liter of the water to be purified in this example was 50 g, and no acid or salt was freshly produced due to the water-purifying agent precursor. Data of a water purification effect in this example was listed in Table 1.

### Comparative Example 1

The apparatus for water purification through flocculation in Example 1 was adopted; the water to be purified was the same as in Example 1, and according to the amount of iron shown in Table 1, acidic iron sulfate was added to the water to be purified; and during a purification process, a pH of a mixed solution was adjusted with a sodium hydroxide solution to 7, so that iron ions in the mixed solution were completely hydrolyzed to produce ferric hydroxide and the ferric hydroxide co-settled with impurities.

It was tested that an amount of ferric iron of ferric hydroxide generated in each liter of the water to be purified in this comparative example was 100 g. The sodium hydroxide solution added during the process reacted with the acidic iron sulfate to freshly produce sodium sulfate. Data of a purification effect in this comparative example was listed in Table 1.

### Comparative Example 2

The apparatus for water purification through flocculation in Example 3 was adopted; the water to be purified was the same as in Example 3, and according to the amount of iron shown in Table 1, acidic iron sulfate was added to the water to be purified; and during a purification process, a pH of the water to be purified was adjusted with sodium hydroxide to 5.

It was tested that an amount of ferric iron of ferric hydroxide generated in each liter of the water to be purified in this comparative example was 500 g. The sodium hydroxide added during the process reacted with the acidic iron sulfate to freshly produce sodium sulfate. Data of a purification effect in this comparative example was listed in Table 1.

### Comparative Example 3

The apparatus for water purification through flocculation in Example 5 was adopted; the water to be purified was the same as in Example 5, and according to the amount of iron shown in Table 1, acidic iron chloride was added to the water to be purified; and during a purification process, a pH of the water to be purified was adjusted with sodium hydroxide to 6.9.

It was tested that an amount of ferric iron of ferric hydroxide generated in each liter of the water to be purified in this comparative example was 0.002 g. The sodium hydroxide added during the process reacted with the acidic iron chloride to freshly produce sodium chloride. Data of a purification effect in this comparative example was listed in Table 1.

### Comparative Example 4

The apparatus in Example 2 was adopted to purify water with a pH of 0.2 to be purified by the method in Example 2 according to the amount shown in Table 1. This comparative example was different from Example 2 in that an inorganic base was not fed into the flocculation sedimentation tank 1 to adjust a pH of a liquid.

It was tested that an amount of ferric iron of ferric hydroxide generated in each liter of the water to be purified in this comparative example was 0.001 g. Data of a purification effect in this comparative example was listed in Table 1.

### Comparative Example 5

The apparatus in Example 5 was adopted to purify water with a pH of 6.9 to be purified by the method in Example 5 according to the amount shown in Table 1. Data of a water purification effect was listed in Table 1.

It was tested that an amount of ferric iron of ferric hydroxide generated in each liter of the water to be purified in this comparative example was 0.001 g. Data of a purification effect in this comparative example was listed in Table 1.

### Comparative Example 6

The apparatus for water purification through flocculation in Example 6 was adopted; and the water to be purified was the same as in Example 6, and according to the amount shown in Table 1, a water-purifying agent precursor ferrous carbonate was added to the water to be purified.

It was tested that an amount of ferric iron of ferric hydroxide generated in each liter of the water to be purified in this comparative example was 700 g. Data of a purification effect in this comparative example was listed in Table 1.

TABLE 1

| | 1 cubic meter of | | Amount of iron | | | |
|---|---|---|---|---|---|---|
| | water to be purified | | from a | | | |
| | 60 | | water-purifying | | | |
| | | COD | agent precursor | | COD value in | |
| | Turbidity, | value, | (g/L - water to be | | purified water | |
| No. | mg/L | mg/L | purified) | Turbidity (mg/L) | (mg/L) | Tyndall effect |
| Example 1 | 16 | 310 | 100 | 5 | 94 | There is a Tyndall effect. |
| Example 2 | 13 | 382 | 10 | 8 | 242 | There is a Tyndall effect. |
| Example 3 | 9 | 500 | 500 | 3 | 199 | There is a Tyndall effect. |
| Example 4 | 8 | 92 | 300 | 1 | 37 | There is a Tyndall effect. |
| Example 5 | 4 | 5 | 0.002 | 1 | 2 | There is a weak Tyndall |
| | | | | | | effect. |
| Example 6 | 6 | 180 | 50 | 1 | 56 | There is a Tyndall effect. |
| Comparative | 16 | 310 | 100 | 5 | 93 | There is a Tyndall effect. |
| Example 1 | | | | | | |
| Comparative | 9 | 500 | 500 | 3 | 202 | There is a Tyndall effect. |
| Example 2 | | | | | | |
| Comparative | 4 | 5 | 0.002 | 1 | 2 | There is a weak Tyndall |
| Example 3 | | | | | | effect. |
| Comparative | 13 | 382 | 10 | 10 | 323 | There is a weak Tyndall |
| Example 4 | | | | | | effect, but a too-small |
| | | | | | | amount of ferric |
| | | | | | | hydroxide is produced |
| | | | | | | and can hardly lead to |
| | | | | | | flocculation and |
| | | | | | | co-sedimentation. |
| Comparative | 4 | 5 | 0.001 | 2 | 3 | There is a weak Tyndall |
| Example 5 | | | | | | effect, but a too-small |
| | | | | | | amount of ferric |
| | | | | | | hydroxide is produced |
| | | | | | | and can hardly lead to |
| | | | | | | flocculation and |
| | | | | | | co-sedimentation. |
| Comparative | 6 | 180 | 700 | A too-large | A too-large | A too-large amount of a |
| Example 6 | | | | amount of a | amount of a | ferric hydroxide colloid is |
| | | | | ferric hydroxide | ferric hydroxide | produced, and thus it is |
| | | | | colloid is | colloid is | difficult to allow SLS by |
| | | | | produced, and | produced, and | the SLS device. |
| | | | | thus it is difficult | thus it is difficult | |
| | | | | to allow SLS by | to allow SLS by | |
| | | | | the SLS device. | the SLS device. | |

It can be seen from Table 1 that Example 1 and Comparative Example 1, Example 3 and Comparative Example 2, or Example 5 and Comparative Example 3 lead to similar purification effects for water to be purified when at a same amount of iron from a hydroxide; and new salts are produced in each of Comparative examples 1 to 3, but the water-purifying agent precursor of the present disclosure does not introduce new anions in water, indicating that the method of the present disclosure can allow a comparable effect to the prior art without producing acids and/or salts during flocculation-based purification.

Example 2 is different from Comparative Example 4 in that, in Example 2, an inorganic base solid is fed into the flocculation sedimentation tank 1 to adjust a pH of water to be treated in the tank to 2 or higher; and in Comparative Example 4, the pH of water to be treated is not adjusted, and thus a hydroxide of iron is partly converted into an iron salt, which reduces an amount of a ferric hydroxide colloid, thereby affecting a water purification effect.

What is claimed is:

1. A method for water purification through fresh generation of a flocculant, comprising the following steps:
(1) mixing a water-purifying agent precursor with a liquid, exciting a resulting mixture, and adding an excited mixture to water to be purified, so that the water-purifying agent precursor undergoes a reaction to produce ferric hydroxide and the ferric hydroxide co-settles with suspended matters and/or impurities in the water to be purified,
wherein the exciting comprises addition of an oxidizing substance; and
(2) subjecting a mixture obtained in step (1) to solid-liquid separation (SLS) to obtain purified water.

2. A method for water purification through fresh generation of a flocculant, comprising the following steps:
(1) mixing a water-purifying agent precursor directly with water to be purified, and exciting a resulting mixture, so that the water-purifying agent precursor undergoes a reaction to produce ferric hydroxide and the ferric hydroxide co-settles with suspended matters and/or impurities in the water to be purified,
wherein the exciting comprises addition of an oxidizing substance; and
(2) subjecting a mixture obtained in step (1) to SLS to obtain purified water.

3. The method for water purification through fresh generation of a flocculant according to claim 2, wherein while the water-purifying agent precursor and the liquid are mixed, excited, and then added to the water to be purified, the water-purifying agent precursor and the water to be purified are directly mixed and excited.

4. The method for water purification through fresh generation of a flocculant according to claim 2, wherein the water-purifying agent precursor is ferrous carbonate and/or ferrous hydroxide; and the liquid is one or a combination of two or more selected from the group consisting of a water-purifying agent precursor aqueous solution, water, and the water to be purified.

5. The method for water purification through fresh generation of a flocculant according to claim 4, wherein the oxidizing substance is one or a combination of two or more selected from the group consisting of oxygen, air, ozone, and hydrogen peroxide.

6. The method for water purification through fresh generation of a flocculant according to claim 5, wherein in step (1), when the oxidizing substance comprises at least one gaseous oxidizing substance selected from the group consisting of oxygen, air, and ozone, the at least one gaseous oxidizing substance is added to the mixture of the water-purifying agent precursor and the liquid in at least one manner selected from the group consisting of jetting, spraying, pumping, aeration, and liquid injection; and
the liquid injection manner is specifically as follows: injecting the mixture of the water-purifying agent precursor and the liquid to a high place based on a pressure, so that the mixture falls to the water to be purified or to the mixture of the water-purifying agent precursor and the water to be purified through a gaseous oxidizing substance-containing environment; or injecting the mixture of the water-purifying agent precursor and the liquid together with the at least one oxidizing substance to a high place based on a pressure, so that the mixture falls to the water to be purified or to the mixture of the water-purifying agent precursor and the water to be purified through a gaseous oxidizing substance-containing environment, wherein during a process of falling from the high place to the water to be purified, the mixture fully contacts the at least one gaseous oxidizing substance to allow an oxidation reaction of the water-purifying agent precursor.

7. The method for water purification through fresh generation of a flocculant according to claim 6, wherein in step (1), the exciting is a combination of the addition of the oxidizing substance with one or more selected from the group consisting of heating and ultrasonic oscillation.

8. The method for water purification through fresh generation of a flocculant according to claim 7, wherein in step (1), there are less than or equal to 300 g of iron from ferrous carbonate as a water-purifying agent precursor and less than or equal to 500 g of iron from ferrous hydroxide as a water-purifying agent precursor in each liter of the water to be purified; and there is more than or equal to 0.002 g of iron from the water-purifying agent precursor in each liter of the water to be purified.

9. The method for water purification through fresh generation of a flocculant according to claim 8, wherein in step (1), a pH of the water to be purified is higher than or equal to 2 to allow for a satisfactory flocculation effect.

10. An apparatus for water purification through flocculation applicable to the method for water purification through fresh generation of a flocculant according to claim 2, comprising a flocculation sedimentation tank, wherein an oxidizing substance-feeding device is further provided, and the oxidizing substance-feeding device is provided with at least one selected from the group consisting of a liquid oxidizing substance outlet, a gaseous oxidizing substance outlet, and a liquid outlet; and the oxidizing substance-feeding device connects to or is arranged in the flocculation sedimentation tank, and is configured to feed an oxidizing substance into the flocculation sedimentation tank.

11. An apparatus for water purification through flocculation applicable to the method for water purification through fresh generation of a flocculant according to claim 1, comprising a flocculation sedimentation tank, wherein a water-purifying agent precursor excitation tank is further provided to form a combination with the flocculation sedimentation tank;
the water-purifying agent precursor excitation tank is configured to excite a water-purifying agent precursor;
an oxidizing substance-feeding device is provided for the water-purifying agent precursor excitation tank or an oxidizing substance-feeding device is provided for both the flocculation sedimentation tank and the water-purifying agent precursor excitation tank; the oxidizing substance-feeding device connects to or is arranged in the corresponding water-purifying agent precursor excitation tank and/or flocculation sedimentation tank, and is configured to feed an oxidizing substance into the water-purifying agent precursor excitation tank and/or the flocculation sedimentation tank; the oxidizing substance-feeding device is provided with at least one selected from the group consisting of a liquid oxidizing substance outlet, a gaseous oxidizing substance outlet, and a liquid outlet; and
a liquid outlet of the water-purifying agent precursor excitation tank is connected to the flocculation sedimentation tank through a pipeline, or the liquid outlet of the oxidizing substance-feeding device arranged in the water-purifying agent precursor excitation tank faces towards the flocculation sedimentation tank, so that a liquid flow is directed into the flocculation sedimentation tank.

12. The apparatus for water purification through flocculation according to claim 10, wherein the oxidizing substance-feeding device is a liquid oxidizing substance-feeding device composed of a temporary storage tank and a pump, or a gas-liquid mixing device configured to mix a gaseous oxidizing substance with a mixture of a water-purifying agent precursor and a liquid; and
the gas-liquid mixing device is at least one selected from the group consisting of a gas-liquid mixing jetting device, a liquid spraying absorption tower, a pumping device, an aeration device, and a liquid injection device.

13. The apparatus for water purification through flocculation according to claim 12, wherein the liquid oxidizing substance-feeding device is provided with a liquid oxidizing substance outlet, the pumping device is provided with a gaseous oxidizing substance outlet, the gas-liquid mixing jetting device and the liquid spraying absorption tower each are provided with a liquid outlet, the aeration device is provided with a gaseous oxidizing substance outlet or a liquid outlet, and the liquid injection device is provided with a liquid outlet;
the pumping device is a combination of a gas pump/compressed gas source with a connection pipeline; and the liquid injection device is a combination of a nozzle with a pipeline having a pump and/or a compressed gas source, and a mixture of a water-purifying agent precursor and a liquid is injected to a gaseous oxidizing substance-containing environment through the combination of the nozzle with the pump and/or the compressed gas source to allow a chemical reaction.

14. The apparatus for water purification through flocculation according to claim 13, wherein the flocculation sedimentation tank and/or the water-purifying agent precursor excitation tank are/is further provided with at least one selected from the group consisting of a heat exchange device and an ultrasonic generator.

15. The apparatus for water purification through flocculation according to claim 14, wherein a sediment tank is further provided at a bottom of the flocculation sedimentation tank, and the flocculation sedimentation tank is provided with a discharge port higher than the sediment tank;
and the sediment tank has an inverted cone structure, and a discharge port is formed at a lowermost bottom of the sediment tank.

16. The apparatus for water purification through flocculation according to claim 15, wherein a stirring device is further provided in the flocculation sedimentation tank and/or the water-purifying agent precursor excitation tank, and is configured to make a water-purifying agent precursor and/or a hydroxide produced therefrom thoroughly mixed with water to be purified; and
the stirring device is specifically one or more selected from the group consisting of a paddle stirring device and a pump-tubular liquid circulator.

17. The apparatus for water purification through flocculation according to claim 16, wherein an SLS device is further provided, and the SLS device is connected to the discharge port of the flocculation sedimentation tank and is configured to allow SLS of a mixture in the flocculation sedimentation tank.

18. The apparatus for water purification through flocculation according to claim 17, wherein a temporary storage tank is further provided; the temporary storage tank is directly connected to the flocculation sedimentation tank and/or the water-purifying agent precursor excitation tank and/or the SLS device, or is connected to the flocculation sedimentation tank and/or the water-purifying agent precursor excitation tank and/or the SLS device through a pump or a solid feeder; and the temporary storage tank is configured to load materials to be involved in water purification, or to temporarily store materials during or after a water purification process.

19. The apparatus for water purification through flocculation according to claim 17, wherein a process data detection device is arranged in the flocculation sedimentation tank and/or the water-purifying agent precursor excitation tank; the process data detection device comprises at least one selected from the group consisting of a liquid-level meter, a specific gravity meter, a viscometer, a turbidimeter, a pH meter, a conductivity meter, an oxidation-reduction potential (ORP) meter, a flow meter, a Tyndall effect detection device, and a chemical oxygen demand (COD) detector; and
the process data detection device and an automatic detection and feeding controller are arranged in the flocculation sedimentation tank and/or the water-purifying agent precursor excitation tank, and the automatic detection and feeding controller is configured to receive data of the process data detection device and automatically control an operation of the apparatus for water purification through flocculation according to the data.

20. The apparatus for water purification through flocculation according to claim 11, wherein the oxidizing substance-feeding device is a liquid oxidizing substance-feeding device composed of a temporary storage tank and a pump, or a gas-liquid mixing device configured to mix a gaseous oxidizing substance with a mixture of a water-purifying agent precursor and a liquid; and
the gas-liquid mixing device is at least one selected from the group consisting of a gas-liquid mixing jetting device, a liquid spraying absorption tower, a pumping device, an aeration device, and a liquid injection device.
